(19) United States
(12) Patent Application Publication
(10) Pub. No.: US 2025/0059063 A1
(43) Pub. Date: Feb. 20, 2025

(54) A POSITIVE ELECTRODE ACTIVE MATERIAL FOR SECONDARY LITHIUM-ION BATTERIES

(71) Applicant: Umicore, Brussels (BE)

(72) Inventors: KyeongSe SONG, Chungcheongnam-do (KR); HeeSuk KU, Chungcheongnam-do (KR); Maxime BLANGERO, Chungcheongnam-do (KR)

(21) Appl. No.: 18/721,936

(22) PCT Filed: Dec. 15, 2022
(86) PCT No.: PCT/EP2022/086063

§ 371 Date: Jun. 20, 2024

(30) Foreign Application Priority Data
Dec. 23, 2021 (EP) 21217447.8

(51) Int. Cl. C01G 51/00

(52) U.S. Cl. CPC C01G 51/42; C01P 2004/03; C01P 2004/51; C01P 2004/61; C01P 2006/10; C01P 2006/12; C01P 2006/40; C01P 2006/80

(57) ABSTRACT

A positive electrode active material for lithium-ion secondary batteries comprises Li, Co, O, and optionally M′. M′ comprises Al and/or Ti and optionally one or more elements selected from the group consisting of Ni, Mn, B, Sr, Mg, Nb, W, F, and Zr. A molar ratio of Co to M′+Co (Co/(M′+Co)) is more than 0.90. The positive electrode active material comprises a first LCO powder and a second LCO powder that are both single-crystalline powders. The first LCO powder has a first median particle size D50_{A} of between 12 μm and 25 μm, the second LCO powder has a second median particle size D50_{B} of between 3 μm and 8 μm, and the volume fraction of the second LCO powder relative to the total volume of the positive electrode active material is between 10% and 40%.

### TECHNICAL FIELD

The present invention relates to a lithium cobalt-based metal oxide (LCO) positive electrode active material for lithium-ion secondary batteries. More specifically, the invention relates to particulate LCO positive electrode active materials comprising a first LCO powder and a second LCO powder.

### BACKGROUND

This invention relates to a single-crystalline positive electrode active material powder for lithium-ion secondary batteries (LIBs), comprising a first LCO powder and a second LCO powder. The first LCO powder has a higher median particle size D50 than the second LCO powder wherein the first LCO powder is single-crystalline.

Such a positive electrode active material comprising a first LCO powder and a second LCO powder wherein the first LCO powder has a higher median particle size D50 than the second LCO powder is already known, for example from WO 2012/171780 A1 (hereafter referenced as WO'780). The document WO'780 discloses a positive electrode active material powder comprising a mixture of large single-crystalline LCO powder and small polycrystalline LCO powder. However, the positive electrode active material according to WO'780 exhibit insufficient high temperature and high voltage stability when applied in an electrochemical cell as measured by coin cell floating test. Moreover, the low powder density leads to the lower electrode density.

It is therefore an object of the present invention to provide a positive electrode active material which is stable in high temperature and high voltage electrochemical cell application, indicated by the low Q floating (QF) and Co dissolution (Co_{Dis}) as determined by coin cell floating test and low thickness increase after 4 hours (T4h) as determined by full cell bulging test. The positive electrode active material of the present invention also shows high powder density as measured by pressed density.

### SUMMARY OF THE INVENTION

The objective of this invention is achieved by providing a positive electrode active material for lithium-ion secondary batteries according to claim 1. It is indeed observed that a better stability and higher pressed density are achieved using a positive electrode active material according to the present invention, as illustrated by examples and supported by the results provided in Table 1 and 2. EX1 teaches a positive electrode active material comprising a first LCO powder and a second LCO powder wherein the first single-crystalline LCO powder has a higher median particle size D50 than the second single-crystalline LCO powder.

### BRIEF DESCRIPTION OF THE FIGURES

By means of further guidance, a figure is included to better appreciate the teaching of the present invention. Said figure is intended to assist the description of the invention and is nowhere intended as a limitation of the presently disclosed invention.

FIGS. 1a, 1b, and 1c show Scanning Electron Microscope (SEM) images of a positive electrode active material powder EX1, CEX1, and CEX2, respectively.

FIG. 1d show second LCO primary particle diameter calculation from SEM images of EX1.

FIG. 2 shows SEM and EDS mapping on an EX1 particle for Co, Al, Ti, and Mg elements. Ti and Mg rich islands are shown on the positive electrode active material particle

FIG. 3 shows particle size distribution graph of EX1 deconvoluted into 2 peaks corresponding to first and second LCO powder, wherein x-axis is particle size in logarithmic scale and y-axis is volume fraction.

FIG. 4 shows a bulging graph as tested in full cell, wherein x-axis is time in hour and y-axis is cell thickness increase in percent.

### DETAILED DESCRIPTION OF THE INVENTION

Unless otherwise defined, all terms used in disclosing the invention, including technical and scientific terms, have the meaning as commonly understood by one of ordinary skill in the art to which this invention belongs.

### Positive Electrode Active Material

In a first aspect, the present invention provides a positive electrode active material for lithium-ion secondary batteries, wherein said positive electrode active material comprises Li (lithium), Co (cobalt), O (oxygen), and optionally M′, wherein M′ comprises Al and/or Ti, and optionally one or more elements selected from: Ni, Mn, B, Sr, Mg, Nb, W, F, and Zr, wherein a molar ratio of Co to M′+Co (Co/(M′+Co)) is more than 0.90 and less than or equal to 1.00, preferably less than 1.00, more preferably 0.99, as determined by ICP-OES analysis,
wherein the positive electrode active material comprises a first LCO powder and a second LCO powder which are both single-crystalline powders, wherein the first LCO powder has a first median particle size D50_{A} of between 12 μm and 25 μm, as determined by laser diffraction particle size analysis,
wherein the second LCO powder has a second median particle size D50_{B} of between 3 μm and 8 μm, as determined by laser diffraction particle size analysis,
wherein the volume fraction of the second LCO powder relative to the total volume of the positive electrode active material is between 10% and 40%, as determined by laser diffraction particle size analysis.

The concept of single-crystalline powders is well known in the technical field of positive electrode active material. It concerns powders having mostly single-crystalline particles. Such powder is a separate class of powders compared to poly-crystalline powders, which are made of particles which are mostly poly-crystalline. The skilled person can easily distinguish such these two classes of powders based on a microscopic image.

Single-crystal particles are also known in the technical field as monolithic particles, one-body particles or and mono-crystalline particles.

Even though a technical definition of a single-crystalline powder is superfluous, as the skilled person can easily recognize such a powder with the help of an SEM, in the context of the present invention, single-crystalline powders may be considered to be defined as powders in which 80% or more of the number of particles are single-crystalline particles. This may be determined on an SEM image having a field of view of at least 45 μm×at least 60 μm (i.e. of at least 2700 μm²), and preferably of: at least 100 μm×100 μm (i.e. of at least 10,000 μm²).

Single-crystalline particles are particles which are individual crystals, or which are formed of a less than five, and preferably at most three, primary particles which are themselves individual crystals. This can be observed in proper microscope techniques like Scanning Electron Microscope (SEM) by observing grain boundaries.

For the determination whether particles are single-crystalline particles, grains which have a largest linear dimension, as observed by SEM, which is smaller than 20% of the median particle size D50 of the powder, as determined by laser diffraction, are ignored. This avoids that particles which are in essence single-crystalline, but which may have deposited on them several very small other grains, for instance a poly-crystalline coating, are inadvertently considered as not being a single-crystalline particle.

Preferably, said positive electrode active material comprises M′.

Preferably M′ comprises Al and Ti.

Preferably, the present invention provides a positive electrode active material according to the first aspect of the invention, wherein the median particle size D50 of volume ratio of said second LCO powder with respect to the total volume of said positive electrode active material is between 10.0 vol. % and 35.0 vol. %. Preferably, said volume ratio is between 15.0 vol. % and 30.0 vol. % and more preferably, said volume ratio is equal to 15.0, 20.0, 25.0, 30.0 vol. % or any value there in between.

In a preferred embodiment, said positive electrode active material according to the first aspect of the invention has a specific surface area (SA) between 0.10 m²/g and 0.25 m²/g, as determined by BET measurement. Preferably, said positive electrode active material has SA of at least 0.11 m²/g, at least 0.12 m²/g, at least 0.13 m²/g, or even at least 0.14 m²/g, or especially at least 0.15 m²/g. Preferably, said positive electrode active material has SA of at most 0.25 m²/g, at most 0.24 m²/g, at most 0.22 m²/g, at most 0.20 m²/g.

In a preferred embodiment, said positive electrode active material according to the first aspect of the invention has a pressed density (PD) between 3.9 g/cm³ and 4.3 g/cm³, as determined after applying a uniaxial pressure of 207 MPa for 30 seconds. Preferably, said positive electrode active material has PD of at least 3.92 g/cm³, at least 3.93 g/cm³, at least 3.94 g/cm³, or even at least 3.95 g/cm³, or especially at least 3.97 g/cm³. Preferably, said positive electrode active material has PD of at most 4.30 g/cm³, at most 4.20 g/cm³, at most 4.15 g/cm³, at most 4.10 g/cm³.

In a preferred embodiment, said positive electrode active material according to the first aspect of the invention has the ratio of the pressed density to the specific surface area (PD/SA) between 19 and 28. Preferably, said positive electrode active material has a PD/SA ratio of at least 20.0, at least 20.5, at least 21.0, or even at least 21.5, or especially at least 22.0. Preferably, said positive electrode active material has a PD/SA ratio of at most 27.0, at most 26.0, at most 25.0, at most 24.5.

In a preferred embodiment, said positive electrode active material comprises particles having Ti and Mg rich islands on the surface of the particles, as determined by a SEM-EDS elemental mapping. Preferably, said Ti and Mg rich islands have a diameter of between 0.2 μm and 3.0 μm, as determined by SEM-EDS elemental mapping analysis.

Preferably, the present invention provides a positive electrode active material according to the first aspect of the invention, wherein said positive electrode active material comprises Li, Co, M′, and oxygen, wherein M′ comprises Al, Ti, and optionally one or more elements selected from: Ni, Mn, B, Sr, Mg, Nb, W, F, and Zr.

### First LCO Powder

The present invention provides a positive electrode active material according to the first aspect of the invention, wherein the first LCO powder comprises single-crystalline powder having a median particle size D50_{A} of between 12 μm and 25 μm, as determined by laser diffraction particle size analysis, and more preferably, the median particle size D50_{A} is equal to 13, 15, 17, 19, 21, 23, 25 μm, or any value there in between.

Preferably, the present invention provides a positive electrode active material according to the first aspect of the invention, wherein the first LCO powder comprises Li, Co, oxygen, and optionally metal M_{A}′ wherein the metal M_{A}′ comprises Al, Ti, and optionally one or more elements selected from: Ni, Mn, B, Sr, Mg, Nb, W, F, and Zr, wherein a molar ratio of Co to M_{A}′+Co (Co/(M_{A}′+Co)) is more than 0.90 and 1.00, preferably less than 1.00, more preferably 0.99. The composition can be determined by known analysis methods, such as ICP-OES (Inductively coupled plasma—optical emission spectrometry).

### Second LCO Powder

Preferably, the present invention provides a positive electrode active material according to the first aspect of the invention, wherein the second LCO powder comprises single-crystalline powder having a median particle size D50_{B} of between 3 μm and 8 μm, as determined by laser diffraction particle size analysis, and more preferably, the median particle size D50_{B} is equal to 3, 4, 5, 6, 7, 8 μm, or any value there in between.

Preferably, said second LCO powder comprises powder having an average primary particle size of between 3 μm and 7 μm, as determined by SEM analysis, and more preferably, the average primary particle size is equal to 3, 4, 5, 6, 7, or any value there in between.

Preferably, the present invention provides a positive electrode active material according to the first aspect of the invention, wherein the first LCO powder comprises Li, Co, oxygen, and optionally a metal M_{A}′ wherein the metal M_{A}′ comprises Al, Ti, and optionally one or more elements selected from: Ni, Mn, B, Sr, Mg, Nb, W, F, and Zr, wherein a molar ratio of Co to M_{A}′+Co (Co/(M_{A}′+Co)) more than 0.90 and 1.00, preferably less than 1.00, more preferably ≤0.99. The composition can be determined by known analysis methods, such as ICP-OES (Inductively coupled plasma—optical emission spectrometry).

### Process to Manufacture the Cathode Active Material

In a second aspect, the present invention provides a process for manufacturing a positive electrode active material comprising the step of:
Step 1) mixing a first lithium cobalt-based metal oxide powder having a median particle size D50_{A} of between 12 μm and 25 μm, a second lithium cobalt-based metal oxide powder having a media particle size D50_{B} of between 3 μm and 8 μm, and TiO₂ so as to obtain a mixture, wherein the first lithium cobalt-based metal oxide powder and the second lithium cobalt-based metal oxide powder are both single-crystalline powder, wherein a weight fraction of said second lithium cobalt-based metal oxide relative to the total weight of said positive electrode active material is between 10% and 40%. Preferably, said weight fraction of said second lithium cobalt-based metal oxide powder with respect to the total weight of said positive electrode active material is between 10 wt. % and 35 wt. %, preferably between 15 wt. % and 30 wt./%.
Step 2) heating the mixture at a temperature of between 700° C. and 1100° C. for a time of between 5 hours and 20 hours. Preferably, said heating temperature is between 800° C. and 1050° C.

### Battery Comprising the Cathode Active Material and Usage Thereof

In a third aspect, the present invention provides a battery cell comprising a positive electrode active material according to the first aspect of the invention.

In a fourth aspect, the present invention provides a use of a positive electrode active material according to the first aspect of the invention in a battery of either one of a portable computer, a tablet, a mobile phone, an electrically powered vehicle, and an energy storage system.

### EXAMPLES

The following examples are intended to further clarify the present invention and are nowhere intended to limit the scope of the present invention.

### 1. Description of Analysis Method

### 1.1. Inductively Coupled Plasma—Optical Emission Spectrometry

The composition of a positive electrode active material powder is measured by the inductively coupled plasma (ICP) method using an Agilent 720 ICP-OES. 1 gram of powder sample is dissolved into 50 mL of high purity hydrochloric acid (at least 37 wt. % of HCl with respect to the total weight of solution) in an Erlenmeyer flask. The flask is covered by a watch glass and heated on a hot plate at 380° C. until the powder is completely dissolved. After being cooled to room temperature, the solution from the Erlenmeyer flask is poured into a first 250 mL volumetric flask. Afterwards, the first volumetric flask is filled with deionized water up to the 250 mL mark, followed by a complete homogenization process (1st dilution). An appropriate amount of the solution from the first volumetric flask is taken out by a pipette and transferred into a second 250 mL volumetric flask for the 2nd dilution, where the second volumetric flask is filled with an internal standard element and 10% hydrochloric acid up to the 250 mL mark and then homogenized. Finally, this solution is used for ICP-OES measurement.

### 1.2. Pressed Density

The pressed density is measured as follows: 3 grams of powder is filled into a pellet die with a diameter “d” of 1.30 cm. A uniaxial load pressure of 207 MPa is applied to the powder in pellet die for 30 seconds. After relaxing the load, the thickness “t” of the pressed powder is measured. The pellet density (PD) is then calculated as

$$\frac{3}{π \times {( d / 2 )}^{2} \times t}$$

in g/cm³.

### 1.3. Scanning Electron Microscope—Electron Dispersive X-Ray Spectroscopy (SEM-EDS)

The morphology of positive electrode active materials is analyzed by a Scanning Electron Microscopy (SEM) technique. The measurement is performed with a JEOL JCM-6100Plus under a high vacuum environment of 9.6×10⁻⁵ Pa at 25° C.

Concentration of Co, Al, Mg, and Ti on the surface of the positive electrode material secondary particles is analyzed by energy-dispersive X-ray spectroscopy (EDS). The EDS is performed by JEOL JSM 7100F SEM equipment with a 50 mm² X-MaxN EDS sensor from Oxford instruments. An EDS analysis of the positive electrode active material particle provides the quantitative element analysis of the particles.

### 1.4. Particle Size Distribution

### 1.4.1. Particle Size Analysis Measurement by Laser Diffraction

The particle size distribution (PSD) of the positive electrode active material powder is measured by laser diffraction particle size analysis using a Malvern Mastersizer 3000 with a Hydro MV wet dispersion accessory after having dispersed each of the powder samples in an aqueous medium. In order to improve the dispersion of the powder, sufficient ultrasonic irradiation and stirring is applied, and an appropriate surfactant is introduced. Median particle size D50 is defined as the particle size at 50% of the cumulative volume % distributions obtained from the Malvern Mastersizer 3000 with Hydro MV measurements.

The first LCO particle size and second LCO particle size can be visually determined from the peaks in a measured particle size distribution, e.g., measured by laser diffraction. The volume fraction of the second LCO powder can be determined by the ratio of area under the curve of second LCO powder divided by the total area under curve of both first and second LCO powder. If needed, the well-known peak deconvolution algorithms may be used.

### 1.4.2. Particle Size Analysis by SEM

The diameter of primary particle is calculated by using ImageJ software (ImageJ 1.52a, National Institutes of Health, USA) according to the following steps:
Step 1) Open the file containing SEM image of positive electrode active material with 1,000 times magnification.
Step 2) Set scale according to the SEM magnification.
Step 3) Draw lines following primary particle edges using polygon selections tool for at least 50 particles. The particles at the edges of image are to be excluded if truncated.
Step 4) Measure the area of the drawn primary particles selected from Set Measurements and Area box.
Step 5) Calculate the particle diameter of each measured area by assuming the particle in the spherical shape following

$$d = 2 \times \sqrt{\frac{area}{π}}$$

and obtain the average particle diameter for at least 50 particles.

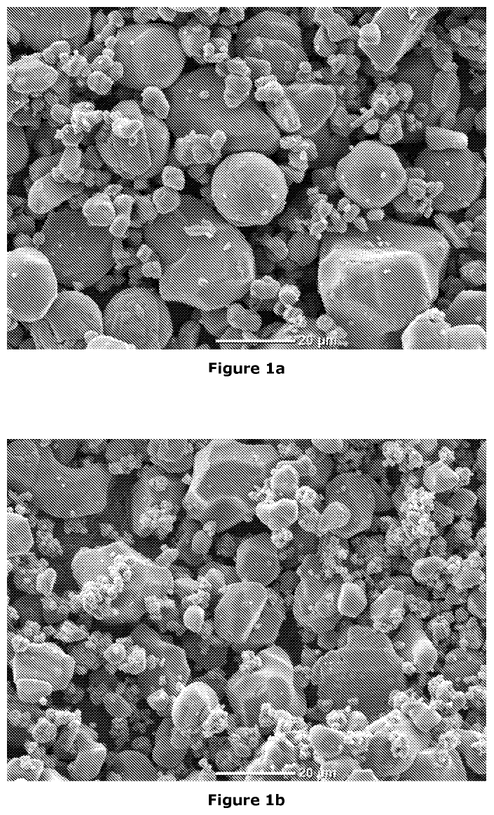

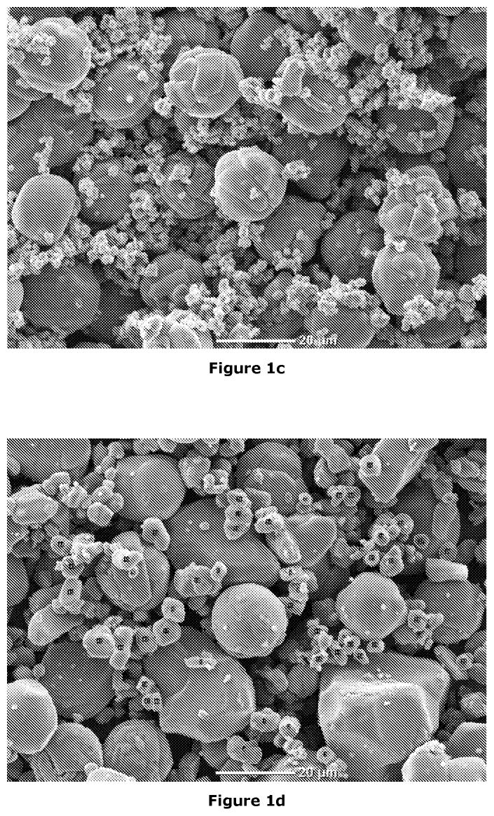

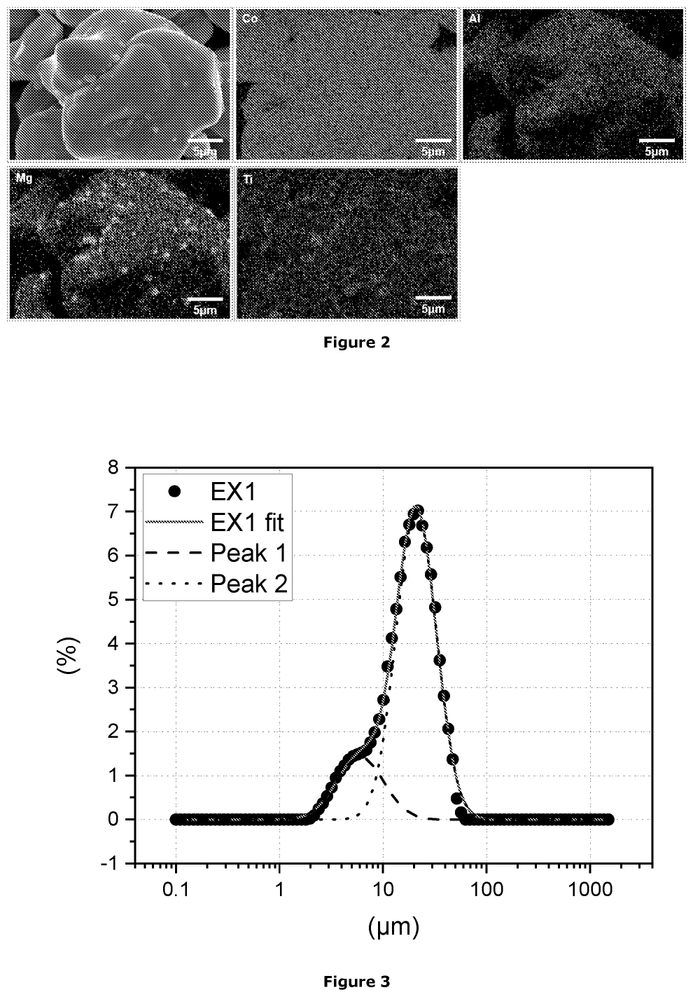

Example of primary particle size calculation for the second LCO of EX1 according to this method is shown in FIG. 1d.

### 1.5. Surface Area

The specific surface area (SA) of the positive electrode active material is measured with the Brunauer-Emmett-Teller (BET) method by using a Micromeritics Tristar II 3020. A powder sample is heated at 300° C. under a nitrogen (N₂) gas for 1 hour prior to the measurement in order to remove adsorbed species. The dried powder is put into the sample tube. The sample is then de-gassed at 30° C. for 10 minutes. The instrument performs the nitrogen adsorption test at 77 K. By obtaining the nitrogen isothermal absorption/desorption curve, the total specific surface area of the sample in m²/g is derived.

### 1.6. Coin Cell

### 1.6.1. Coin Cell Preparation

Coin cells that are used in a floating test analysis are assembled according to the following steps:

### Step 1) Preparation of a Cathode

A slurry that contains the solids: a LCO cathode active material powder, a conductor (Super P, Timcal) and a binder (KF #9305, Kureha) in a weight ratio 90:5:5, and a solvent (NMP, Sigma-Aldrich) are mixed in a high-speed homogenizer so as to obtain a homogenized slurry. The homogenized slurry is spread on one side of an aluminum foil using a doctor blade coater with a 230 μm gap. the slurry-coated aluminum foil is dried in an oven at 120° C., then pressed using a calendaring tool, and dried again in a vacuum oven to remove the solvent completely.

### Step 2) Coin Cell Assembly

A coin cell is assembled in a glovebox which is filled with an inert gas (argon). For the discharge capacity analysis, a separator (Celgard) is located between the cathode and graphite is used as an anode. For the floating test, two pieces of separator are located between the cathode and an anode. 1 M LiPF₆ in EC:DMC (1:2 in volume) is used as electrolyte and dropped between separator and electrodes. Then, the coin cell is completely sealed to prevent leakage of electrolyte.

### 1.6.2. Floating Test Analysis

The floating test analyses the crystal-stability of LCO compounds at a high voltage at an elevated temperature.

The prepared coin cell is tested according to the following charge protocol: the coin cell is first charged to 4.5 V at constant current mode with C/20 rate (1 C=160 mAh/g) in a 50° C. chamber. The coin cell is then kept at constant voltage (4.5 V) for 5 days (120 hours).

Once side reactions or metal dissolution happen, there will be a voltage drop. The electrochemical instrument will automatically compensate the (loss of) current to keep the voltage constant. Therefore, the recorded current is a measure of the ongoing side reactions during cycling.

The specific floating capacity (QF) is the total amount capacity (mAh/g) during the floating test. After the floating test, the coin cell is disassembled. The anode and the separator (located next to the anode) are analyzed by ICP-OES for a metal dissolution analysis. The measured cobalt content is normalized by the total amount of active material in the electrode so that a specific cobalt dissolution value (CO_{DS}) is obtained.

### 1.7. Full Cell

### 1.7.1. Description of Full Cell Preparations

2000 mAh pouch-type batteries are prepared as follows: the positive electrode material powder, Carbon black (LITX200, Carbot) and MWCNT (LB-107, Cnano) as positive electrode conductive agents and polyvinylidene fluoride (PVdF, S5130 commercially available from Solvay) as a positive electrode binder are added to NMP (N-methyl-2-pyrrolidone) as a dispersion medium. The mass ratio of the positive electrode material powder, carbon black, MWCNT, and binder is set at 97.8/0.5/0.7/1. Thereafter, the mixture is kneaded to prepare a positive electrode mixture slurry. The resulting positive electrode mixture slurry is then applied onto both sides of a positive electrode current collector, made of a 20 μm thick aluminum foil for 2000 mAh pouch-type batteries. The positive electrode active material loading weight is around ˜17 mg/cm². The electrode is then dried and calendared using a pressure of 5.0 MPa and press roll gap of 10 μm. The typical electrode density is 4.08 g/cm³. In addition, an aluminum plate serving as a positive electrode current collector tab is arc-welded to an end portion of the positive electrode.

Commercially available negative electrodes are used. In short, a mixture of graphite, Carbon (Super P), CMC (carboxy-methyl-cellulose-sodium) and SBR (styrene butadiene-rubber), in a mass ratio of 95/1/1.5/2.5, is applied on both sides of a copper foil. A nickel plate serving as a negative electrode current collector tab is arc-welded to an end portion of the negative electrode.

A sheet of the positive electrode, a sheet of the negative electrode, and a sheet of a conventional separator (e.g., a ceramic coated separator with a thickness of 13 μm and having a porosity superior or equal to 30% and inferior or equal to 50%; preferably of between 39 to 44% interposed between them are spirally wound using a winding core rod to obtain a spirally wound electrode assembly. The wound electrode assembly and the electrolyte are then put in an aluminum laminated pouch in an air-dry room with dew point of −50° C., so that a flat pouch-type lithium secondary battery is prepared. The design capacity of the secondary battery is around 2000 mAh when charged to 4.45 V.

The non-aqueous electrolyte solution is impregnated for 8 hours at room temperature. The battery is pre-charged at 15% of its theoretical capacity and aged 1 day at room temperature. The battery is then degassed, and the aluminum pouch is sealed. The battery is prepared for use as follows: the battery is charged using a current of 0.2 C (with 1 C=2000 mAh) in CC mode (constant current) up to 4.45 V then CV mode (constant voltage) until a cut-off current of C/20 is reached. Then, the battery is discharged in CC mode at 0.2 C rate down to a cut-off voltage of 3.0 V.

### 1.7.2. Bulging Testing Methods

Pouch-type batteries prepared by the above preparation method are fully charged until 4.45V and inserted in an oven which is heated to 90° C., then stay for 20 hours. At 90° C., the charged cathode reacts with electrolyte and creates gas. The evolved gas creates bulging. The thickness change ((thickness after storage before storage)/thickness before storage) is recorded every hour.

### 2. EXAMPLES AND COMPARATIVE EXAMPLES

### Example 1

A positive electrode active material labelled as EX1 is prepared according to the following steps:

Step 1) Preparing EX1-A, which is a single-crystalline positive electrode active material, according to below steps:
a. First mixing: Co₃O₄ powder having D50 of 20 μm is mixed with Li₂CO₃, Al₂O₃, and MgO, to obtain a first mixture having a lithium to metal (Li/(Al+Co)) ratio of 1.05, Al/Co molar ratio of 0.015, and Mg/Co molar ratio of 0.005.
b. First heating: First mixture from Step 1.a) is heated at 1050° C. under dry air atmosphere for 12 hours in a furnace to obtain a first heated powder.
c. Post treatment: the first heated powder from Step 1.c) is grinded and sieved to obtain EX1-A.

Step 2) Preparing EX1-B, which is a single-crystalline positive electrode active material, according to below steps:
a. Second mixing: Co₃O₄ powder having D50 of 6 μm is mixed with Li₂CO₃, Al₂O₃, and MgO, to obtain a second mixture having a lithium to metal (Li/(Al+Co)) ratio of 1.05, Al/Co molar ratio of 0.015, and Mg/Co molar ratio of 0.005.
b. Second heating: Second mixture from Step 2.a) is heated at 1050° C. under dry air atmosphere for 12 hours in a furnace to obtain the second heated powder.
c. Post treatment: the second heated powder from Step 1.c) is grinded and sieved to obtain EX1-B.

Step 3) Preparing EX1, which is a mixture of single-crystalline EX1-A and single-crystalline EX1-B according to below steps:
a. Third mixing: EX1-A, EX1-B, COH, and TiO₂ are mixed to obtain a third mixture having weight ratio of EX1-A:EX1-B=80%:20%, Li/(Co+Al) molar ratio of 1.00, and Ti/Co molar ratio of 0.0015. COH is Co_{0.980}Al_{0.015}Mg_{0.005}(OH)₂ powder having a median particle size D50 of 100 nm.
b. Third heating: Third mixture from Step 4.a) is heated at 1050° C. under dry air atmosphere for 12 hours in a furnace to obtain the third heated powder.
c. Post treatment: the third heated powder from Step 4.c) is grinded and sieved to obtain EX1-B.

### Comparative Example 1

A positive electrode active material labelled as CEX1 is prepared according to the following steps:

Step 1) Preparing CEX1-A, which is a single-crystalline positive electrode active material, according to below steps:
a. First mixing: Co₃O₄ powder having D50 of 2 μm is mixed with Li₂CO₃, MgO, and TiO₂ to obtain a first mixture having a lithium to metal (Li/Co) ratio of 1.06, Mg/Co molar ratio of 0.0025, and Ti/Co molar ratio of 0.0008.
b. First heating: First mixture from Step 1.a) is heated at 1000° C. under dry air atmosphere for 12 hours in a furnace to obtain a first heated powder.
c. Post treatment: the first heated powder from Step 1.c) is grinded and sieved to obtain CEX1-A.

Step 2) Preparing CEX1, which is a mixture of CEX1-A and Co₃O₄ according to below steps:
a. Second mixing: CEX1-A, Li₂CO₃, Co₃O₄, MgO, TiO₂ and Al₂O₃ are mixed to obtain a second mixture having Li/Co molar ratio of 1.00, Mg/Co molar ratio of 0.01, Ti/Co molar ratio of 0.0028, and Al/Co molar ratio of 0.01, wherein 13 mol % Co is added compared to the cobalt in CEX1-A.
b. Second heating: Second mixture from Step 2.a) is heated at 980° C. under dry air atmosphere for 10 hours in a furnace to obtain the second heated powder.
c. Post treatment: the second heated powder from Step 2.c) is grinded and sieved to obtain CEX1.

CEX1 is according to WO'780.

### Comparative Example 2

A positive electrode active material labelled as CEX2 is prepared according to the following steps:

Step 1) Preparing CEX2-A, which is a single-crystalline positive electrode active material, according to below steps:
a. First mixing: Co₃O₄ powder having D50 of 20 μm is mixed with Li₂CO₃, Al₂O₃, and MgO, to obtain a first mixture having a lithium to metal (Li/(Al+Co)) ratio of 1.03, Al/Co molar ratio of 0.015, and Mg/Co molar ratio of 0.005.
b. First heating: First mixture from Step 1.a) is heated at 1050° C. under dry air atmosphere for 12 hours in a furnace to obtain a first heated powder.
c. Post treatment: the first heated powder from Step 1.c) is grinded and sieved to obtain CEX2-A.

Step 2) Preparing CEX2-B, which is a Co₃O₄ comprising Al and Mg, according to below steps:
a. Second mixing: Co₃O₄ powder having D50 around 2 μm is mixed with Al₂O₃ and MgO, to obtain a second mixture having Al/Co molar ratio of 0.015 and Mg/Co molar ratio of 0.005.
b. Second heating: Mixture from Step 2.a) is heated at 800° C. under dry air atmosphere for 12 hours in a furnace to obtain CEX2-B.

Step 3) Preparing CEX2, which is a mixture of single-crystalline CEX2-A and polycrystalline CEX2-B according to below steps:
a. Third mixing: CEX2-A, CEX2-B, Li₂CO₃, and TiO₂ are mixed to obtain a third mixture having Li/(Co+Al) molar ratio of 1.00, and Ti/Co molar ratio of 0.0015, wherein 15 mol % Co is added compared to the cobalt in CEX2-A.
b. Third heating: Third mixture from Step 3.a) is heated at 980° C. under dry air atmosphere for 12 hours in a furnace to obtain the second heated powder.
c. Post treatment: the second heated powder from Step 3.c) is grinded and sieved to obtain CEX2.

TABLE 1
Summary of the first and second LCO powder composition
of example and comparative examples.

| | | | | | 2^{nd} |
|---|---|---|---|---|---|
| | | | | | LCO |
| | | | | | powder |
| | 1^{st} LCO powder | | 2^{nd} LCO powder | | fraction |
| | | D50_{A} | | D50_{B} | (vol. |
| ID | morphology | (μm)* | morphology | (μm)* | %)* |
| EX1 | single-crystalline | 21.0 | Single-crystal- | 6.0 | 19.2 |
| | | | line | | |
| CEX1 | single-crystalline | 19.0 | Polycrystalline | 7.8 | 27.2 |
| CEX2 | single-crystalline | 17.3 | Polycrystalline | 6.8 | 10.8 |

*as measured by PSD peak deconvolution

TABLE 2
Summary of the atomic composition, specific surface area, pressed density,
and electrochemical test result of example and comparative examples.

| | | | | | | | | Coin cell | | Full cell |
|---|---|---|---|---|---|---|---|---|---|---|
| | Molar composition by ICP-OES | | | | SA | PD | | QF | Co_{Dis} | T4h |
| ID | Li/(Co + Al) | Al/Co | Mg/Co | Ti/Co | (m²/g) | (g/cm³) | PD/SA | (mAh/g) | (mg/g) | (%) |
| EX1 | 0.992 | 0.0145 | 0.0046 | 0.0012 | 0.17 | 4.04 | 23.76 | 108 | 11.0 | 11% |
| CEX1 | 0.996 | 0.0100 | 0.0100 | 0.0028 | 0.22 | 3.96 | 18.00 | 316 | 24.9 | 105% |
| CEX2 | 0.980 | 0.0141 | 0.0050 | 0.0015 | 0.18 | 3.94 | 21.89 | 161 | 18.0 | 38% |

Table 1 summarized 1^{st} and 2^{nd} LCO powder components of EX1, CEX1, and CEX2. EX1 comprises 1^{st} and 2^{nd} LCO powder having single-crystalline morphology as shown by SEM image in FIG. 1a. On the other hand, CEX1 and CEX2 are the mixture of first single-crystalline LCO powder and second polycrystalline LCO powder. SEM images of CEX1 and CEX2 are shown in FIGS. 1b and 1c, respectively.

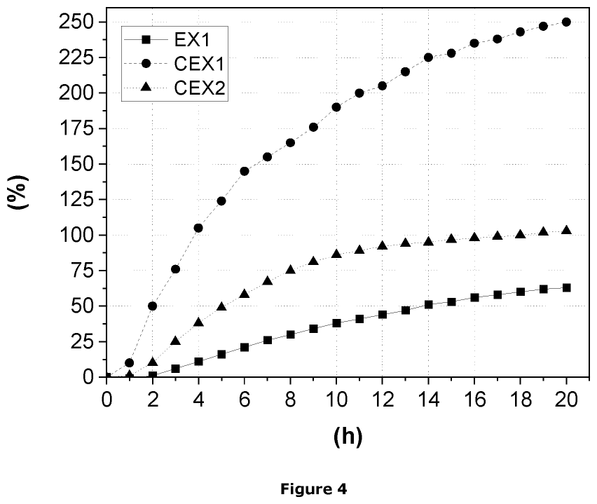

FIG. 4 shows particle size analysis distribution graph of EX1. According to the graph, the first median particle size D50_{A} is around 21 μm and the second median particle size D50_{B} is around 6 μm. Volume fraction of second LCO powder is 19.2 vol. %.

Table 2 summarizes the composition, specific surface area, pressed density, and electrochemical test result of example and comparative examples. EX1 shows the lowest specific surface area SA in comparison with CEX1 and CEX2. The low specific surface area is linked to the high stability in the high temperature and high voltage as indicated by low QF, low Co_{Dis}, and low T4h. Additionally, EX1 exhibit high pressed density PA in comparison with CEX1 and CEX2. The superior performance of EX1 in the stability and the density is originated from the composition mixture comprising large 1^{st} LCO single-crystalline powder and small 2^{nd} LCO single-crystalline powder.

It is concluded that EX1 meets the objective of this invention: to provide a positive electrode active material which is stable in high temperature and high voltage electrochemical cell application and having high pressed density.

1-20. (canceled)

21. A positive electrode active material for lithium-ion secondary batteries, wherein said positive electrode active material comprises Li, Co, O, and optionally M′ wherein M′ comprises Al and/or Ti, and optionally one or more elements selected from the group consisting of Ni, Mn, B, Sr, Mg, Nb, W, F, and Zr, wherein a molar ratio of Co to M′+Co (Co/(M′+Co)) is more than 0.90, as determined by ICP-OES analysis, and
wherein the positive electrode active material comprises a first LCO powder and a second LCO powder that are both single-crystalline powders,
wherein the first LCO powder has a first median particle size D50_{A} of between 12 μm and 25 μm, as determined by laser diffraction particle size analysis, the second LCO powder has a second median particle size D50_{B} of between 3 μm and 8 μm, as determined by laser diffraction particle size analysis, and the volume fraction of the second LCO powder relative to the total volume of the positive electrode active material is between 10% and 40%, as determined by laser diffraction particle size analysis.

22. The positive electrode active material according to claim 21, wherein said positive electrode active material comprises M′.

23. The positive electrode active material according to claim 21, wherein M′ comprises Al and Ti.

24. The positive electrode active material according to claim 21, wherein said second LCO powder comprises powder having an average primary particle size of between 3 μm and 7 μm, as determined by SEM analysis.

25. The positive electrode active material according to claim 21, wherein said positive electrode active material has a specific surface area of between 0.10 m²/g and 0.25 m²/g, as determined by BET analysis.

26. The positive electrode active material according to claim 21, wherein said positive electrode active material has a pressed density, after applying a uniaxial pressure of 207 MPa for 30 seconds, of between 3.9 g/cm³ and 4.3 g/cm³.

27. The positive electrode active material according to claim 26, wherein the ratio of the pressed density to the specific surface area is between 19.0 and 28.0.

28. The positive electrode active material according to claim 21, wherein said positive electrode comprises M′, wherein M′ comprises Ti and/or Mg.

29. The positive electrode active material according to claim 21, wherein said first LCO powder comprises particles having Ti and/or Mg rich islands on the surface of the particles, as determined by a SEM-EDS elemental mapping.

30. The positive electrode active material according to claim 21, wherein said first LCO powder comprises particles having Ti and Mg rich islands on the surface of the particles, as determined by a SEM-EDS elemental mapping.

31. The positive electrode active material according to claim 30, wherein said Ti and Mg rich islands have a diameter of between 0.2 μm and 3.0 μm, as determined by SEM analysis.

32. The positive electrode active material according to claim 21, wherein said second median particle size D50_{B} is between 5 μm and 7 μm.

33. The positive electrode active material according to claim 21, wherein the volume fraction of the second LCO powder relative to the total volume of the positive electrode active material is between 15% and 30%.

34. The positive electrode active material according to claim 21, wherein said positive electrode material comprises Li, Co, a metal M′ and O, wherein the metal M′ comprises Al, Ti, and Mg, and wherein the molar ratio of Al to Co (Al/Co) is between 0.001 and 0.030, the molar ratio of Mg to Co (Mg/Co) is between 0.001 and 0.020, and the molar ratio of Ti to Co (Ti/Co) is between 0.001 and 0.005, as determined by ICP-OES analysis.

35. The positive electrode active material according to claim 21, wherein said positive electrode material has a specific floating capacity of between 10 mAh/g and 150 mAh/g, as determined by an electrochemical analysis at 4.5V and 50° C. for 120 hours.

36. A method for manufacturing a positive electrode active material according to claim 21, wherein the method comprises steps:
1) mixing a first lithium cobalt-based metal oxide powder having a median particle size D50_{A} of between 12 μm and 25 μm, a second lithium cobalt-based metal oxide powder having a median particle size D50_{B} of between 3 μm and 8 μm, and TiO₂ so as to obtain a mixture, wherein the first lithium cobalt-based metal oxide powder and the second lithium cobalt-based metal oxide powder are both single-crystalline powders, wherein a weight fraction of said second lithium cobalt-based metal oxide relative to the total weight of said positive electrode active material is between 10% and 40%, and
2) heating the mixture at a temperature of between 700° C. and 1100° C. for a time of between 5 hours and 20 hours.

37. The method according to claim 36, wherein step 1) is: mixing a first lithium cobalt-based metal oxide powder having a median particle size D50_{A} of between 12 μm and 25 μm, a second lithium cobalt-based metal oxide powder having a median particle size D50_{B} of between 3 μm and 8 μm, a Co-based compound having a median particle size D50c of less than 300 nm, and TiO₂ so as to obtain a mixture, wherein the first lithium cobalt-based metal oxide powder and the second lithium cobalt-based metal oxide powder are both single-crystalline powders, wherein a weight fraction of said second lithium cobalt-based metal oxide relative to the total weight of said positive electrode active material is between 10% and 40%.

38. The method according to claim 37, wherein said Co-based compound has a median particle size D50c of less than 150 nm and said Co-based compound comprises Al and/or Mg.

39. A battery cell comprising a positive electrode active material according to claim 21.

40. A portable computer, a tablet, a mobile phone, a power tool, an electrically powered vehicle, or an energy storage system comprising a battery according to claim 39.
